(19) United States
(12) Patent Application Publication
(10) Pub. No.: US 2017/0024462 A1
(43) Pub. Date: Jan. 26, 2017

(54) ASSOCIATING A TEXT MESSAGE CONTAINING AN ANSWER WITH A TEXT MESSAGE CONTAINING A QUESTION

(71) Applicant: International Business Machines Corporation, Armonk, NY (US)

(72) Inventors: Corville O. Allen, Morrisville, NC (US); Mario A. Maldari, Longmont, CO (US); Monica A. Senior, College Park, GA (US); Paul A. Smith, Cary, NC (US)

(21) Appl. No.: 14/807,053

(22) Filed: Jul. 23, 2015

(51) Int. Cl. G06F 17/30

(52) U.S. Cl. CPC G06F 17/30684; G06F 17/30654; G06F 17/30643

(57) ABSTRACT

A first text message containing a first question can be received from a first user. A second text message containing a second question can be received from the first user or a second user. A third text message containing an answer can be received from a third user. Whether the third user begins typing the third text message after the first text message is received and before the second text message is received can be determined. Responsive to determining that the second user begins typing the third text message after the first text message is received and before the second text message is received, a determination can be made that the answer pertains to the first question. Responsive to determining that the answer pertains to the first question, the third text message can be configured for presentation in a manner indicating that the answer pertains to first question.

### BACKGROUND

The present invention relates to electronic communications, and more specifically, to electronic messaging.

Text messaging, instant messaging and online social networking are used universally for people to connect with each other and share information in logical and organized ways. Common mechanisms for sharing and processing information are text messaging systems, instant messaging systems, social networking systems, forums and chatrooms. These mechanisms enable users to rapidly share information with others and gather information from others.

### SUMMARY

A method includes receiving from a first user a first text message containing a first question. The method also includes receiving from the first user or a second user a second text message containing a second question. The method also includes receiving from a third user a third text message containing an answer. The method also includes automatically determining whether the third user begins typing the third text message after the first text message is received and before the second text message is received. The method also includes, responsive to determining that the second user begins typing the third text message after the first text message is received and before the second text message is received, automatically determining, using a processor, that the answer pertains to the first question. The method also includes, responsive to determining that the answer pertains to the first question, configuring the third text message for presentation to the third user, and the first user or the second user, on respective displays in a manner indicating that answer contained in the third text message pertains to first question contained in the first text message and does not pertain to the second question contained in the second text message.

A system includes a processor programmed to initiate executable operations. The executable operations include receiving from a first user a first text message containing a first question. The executable operations also include receiving from the first user or a second user a second text message containing a second question. The executable operations also include receiving from a third user a third text message containing an answer. The executable operations also include automatically determining whether the third user begins typing the third text message after the first text message is received and before the second text message is received. The executable operations also include, responsive to determining that the second user begins typing the third text message after the first text message is received and before the second text message is received, automatically determining that the answer pertains to the first question. The executable operations also include, responsive to determining that the answer pertains to the first question, configuring the third text message for presentation to the third user, and the first user or the second user, on respective displays in a manner indicating that answer contained in the third text message pertains to first question contained in the first text message and does not pertain to the second question contained in the second text message.

A computer program includes a computer readable storage medium having program code stored thereon. The program code is executable by a processor to perform a method. The method includes receiving, by the processor, from a first user a first text message containing a first question. The method also includes receiving, by the processor, from the first user or a second user a second text message containing a second question. The method also includes receiving, by the processor, from a third user a third text message containing an answer. The method also includes automatically determining, by the processor, whether the third user begins typing the third text message after the first text message is received and before the second text message is received. The method also includes, responsive to determining that the second user begins typing the third text message after the first text message is received and before the second text message is received, automatically determining, by the processor, that the answer pertains to the first question. The method also includes, responsive to determining that the answer pertains to the first question, configuring, by the processor, the third text message for presentation to the third user, and the first user or the second user, on respective displays in a manner indicating that answer contained in the third text message pertains to first question contained in the first text message and does not pertain to the second question contained in the second text message.

### BRIEF DESCRIPTION OF THE DRAWINGS

FIG. 1 is a block diagram illustrating an example of a communication system.

FIG. 2 is a block diagram illustrating example architecture for a client device.

FIG. 3 is a block diagram illustrating example architecture for a server.

FIG. 4 is a diagram illustrating text messages exchanged among a plurality of users during a conversation.

FIG. 5 is a diagram illustrating a view of a user interface via which text messages are presented.

FIG. 6 is another diagram illustrating a view of a user interface via which text messages are presented.

FIG. 7 is another diagram illustrating a view of a user interface via which text messages are presented.

FIG. 8 is a flow chart illustrating an example of a method of associating a text message containing an answer to a question with a text message containing the question.

FIG. 9 is a flow chart illustrating another example of a method of associating a text message containing an answer to a question with a text message containing the question.

### DETAILED DESCRIPTION

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to electronic communications, and more specifically, to electronic messaging. In accordance with the inventive arrangements disclosed herein, a text message which includes an answer to a question presented in a previous text message can be automatically associated with the previous text message, even if other text messages have been received prior to the text message containing the answer.

Several definitions that apply throughout this document now will be presented.

As defined herein, the term “text message” means electronically communicated data representing text. A text message can be an electronic message sent via a short message service (SMS), a multimedia messaging service (MMS), instant messaging or the like. A text message also can be an electronic message communicated as a post in a chatroom or forum. An electronic mail (e-mail), however, is not a text message as the term text message is defined herein.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “computer readable storage medium” means a storage medium that contains or stores program code for use by or in connection with an instruction execution system, apparatus, or device. As defined herein, a “computer readable storage medium” is not a transitory, propagating signal per se.

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “real time” means a level of processing responsiveness that a user or system senses as sufficiently immediate for a particular process or determination to be made, or that enables the processor to keep up with some external process.

As defined herein, the term “output” means storing in memory elements, writing to display or other peripheral output device, sending or transmitting to another system, exporting, or the like.

As defined herein, the term “automatically” means without user intervention.

As defined herein, the term “user” means a person (i.e., a human being).

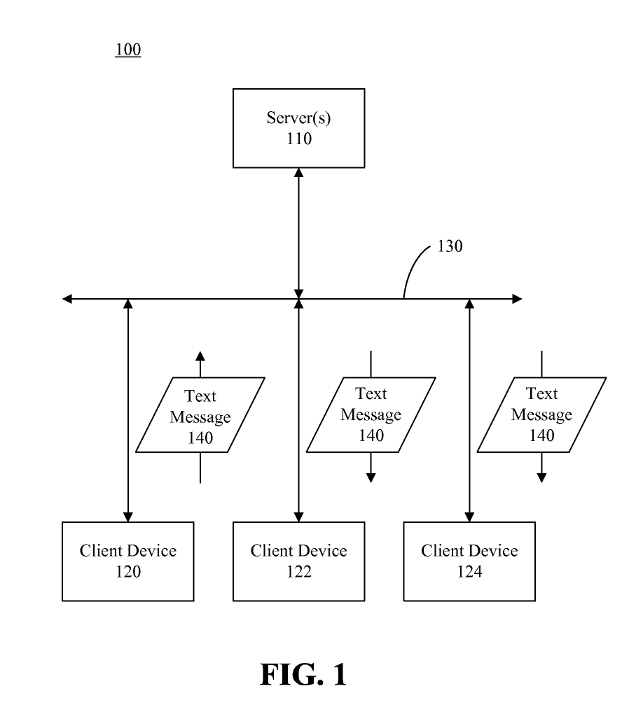

FIG. 1 is a block diagram illustrating an example of a communication system 100. The communication system 100 can include one or more servers 110 and two or more client devices 120, 122, 124 communicatively linked via one or more communication networks 130. The communication network(s) 130 is the medium used to provide communications links between the server(s) 110 and the various client devices 120-124 connected together within the communication system 100. The communication network(s) 130 may include connections, such as wire, wireless communication links, or fiber optic cables. The communication network(s) 130 can be implemented as, or include, any of a variety of different communication technologies such as a wide area network (WAN), a local area network (LAN), a wireless network, a mobile network, a Virtual Private Network (VPN), the Internet, the Public Switched Telephone Network (PSTN), or the like.

Each client device 120-124 can be implemented as a processing system comprising at least one processor and memory configured to send and receive text messages. Examples of a client device 120-124 include, but are not limited to, a workstation, a desktop computer, a laptop computer, a tablet computer, a netbook computer, a mobile computer, a smart phone, a personal digital assistant, a gaming device or system, a set-top box, a set-top unit, a network appliance, and the like.

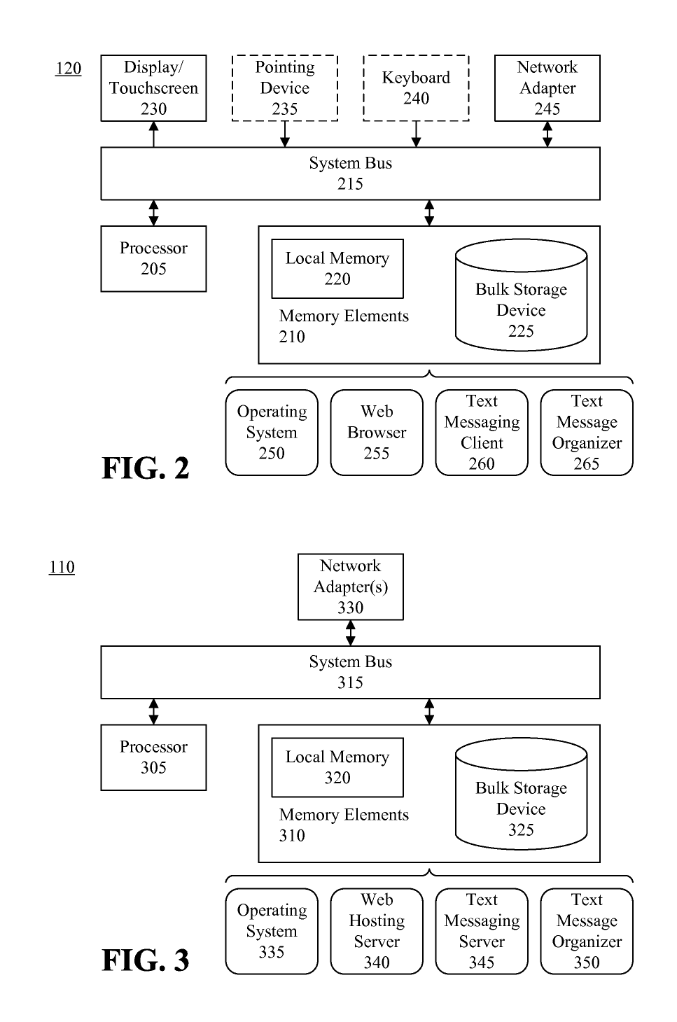

FIG. 2 is a block diagram illustrating example architecture for a client device, such as the client device 120. The client devices 122-124 may be configured in a similar manner. The client device 120 can include at least one processor 205 (e.g., a central processing unit) coupled to memory elements 210 through a system bus 215 or other suitable circuitry. As such, the client device 120 can store program code within the memory elements 210. The processor 205 can execute the program code accessed from the memory elements 210 via the system bus 215. It should be appreciated that the client device 120 can be implemented in the form of any system including a processor and memory that is capable of performing the functions and/or operations described within this specification.

The memory elements 210 can include one or more physical memory devices such as, for example, local memory 220 and one or more bulk storage devices 225. Local memory 220 refers to random access memory (RAM) or other non-persistent memory device(s) generally used during actual execution of the program code. The bulk storage device(s) 225 can be implemented as a hard disk drive (HDD), solid state drive (SSD), or other persistent data storage device. The client device 120 also can include one or more cache memories (not shown) that provide temporary storage of at least some program code in order to reduce the number of times program code must be retrieved from the bulk storage device 225 during execution.

Input/output (I/O) devices such as a display (e.g., a conventional display or a touchscreen) 230 and, optionally, a pointing device 235 and a keyboard 240 can be coupled to the client device 120. The I/O devices can be coupled to the client device 120 either directly or through intervening I/O controllers. For example, the display 230 can be coupled to the client device 120 via a graphics processing unit (GPU), which may be a component of the processor 205 or a discrete device. One or more network adapters 245 also can be coupled to client device 120 to enable the client device 120 to become coupled to other systems, computer systems, remote printers, and/or remote storage devices through intervening private or public networks. Modems, cable modems, transceivers, and Ethernet cards are examples of different types of network adapters 245 that can be used with the client device 120.

As pictured in FIG. 2, the memory elements 210 can store the components of the client device 120, for example an operating system 250, a web browser 255, a text messaging client 260 and, optionally, a text message organizer 265. The text message organizer 265 can be implemented as a plug-in for the web browser 255 and/or the text messaging client 260, or can be a stand-alone application. Being implemented in the form of executable program code, these components of the client device 120 can be executed by the client device 120 and, as such, can be considered part of the client device 120. Moreover, the operating system 250, web browser 255, text messaging client 260 and, optionally, text message organizer 265 are functional data structures that impart functionality when employed as part of the client device 120. Further, the text messages processed by the operating system 250, web browser 255, text messaging client 260 and, optionally, text message organizer 265, including any parameters and/or attributes utilized to process text messages, are functional data structures that impart functionality when employed as part of client device 120. Each text message, including any parameters and/or attributes utilized to process text messages, can be output to, and stored within, memory elements 210. The text messages also can be presented by the client device 120 on the display 230, organized in a manner which will be described herein.

Referring again to FIG. 1, each server 110 can be implemented as a processing system comprising at least one processor and memory configured to receive text messages from client devices 120-124 and send the text messages to other client devices 120-124. For example, a user can, using the client device 120, generate a text message 140 and send the text message to one or more users who are intended recipients of the text message 140, for example users of the client devices 122-124. The text message 140 can be routed to the server(s) 110 via the communication network(s) 130. In one arrangement, for example an arrangement in which the text message is sent via SMS, MMS or instant messaging, the server(s) 110 can process the text message and route the text message 140 to the client devices 122-124 used by the intended recipients. In another arrangement, for example an arrangement in which the text message is intended to be a post to a chatroom or forum, the server(s) 110 can post the text message to the chatroom or forum as a post. The server(s) 110 can communicate the text message 140 to the client devices 120-124 when the client devices 120-124 are used to access a thread in which the text message 140 is posted. For instance, the at least a portion of the thread including the text message 140 can be communicated to the client devices 120-124 when the users access the thread.

FIG. 3 is a block diagram illustrating example architecture for the server 110. The server 110 can include at least one processor 305 (e.g., a central processing unit) coupled to memory elements 310 through a system bus 315 or other suitable circuitry. As such, the server 110 can store program code within the memory elements 310. The processor 305 can execute the program code accessed from the memory elements 310 via the system bus 315. It should be appreciated that the server 110 can be implemented in the form of any system including a processor and memory that is capable of performing the functions and/or operations described within this specification. In this regard, the server 110 can be a hardware server.

The memory elements 310 can include one or more physical memory devices such as, for example, local memory 320 and one or more bulk storage devices 325. Again, local memory 320 refers to RAM or other non-persistent memory device(s) generally used during actual execution of the program code. The bulk storage device(s) 325 can be implemented as a HDD, SSD, or other persistent data storage device. The server 110 also can include one or more cache memories (not shown) that provide temporary storage of at least some program code in order to reduce the number of times program code must be retrieved from the bulk storage device 325 during execution.

Input/output (I/O) devices such as one or more network adapters 330 can be coupled to the server 110. The network adapter(s) 330 can be coupled to the server 110 either directly or through intervening I/O controllers. The network adapter(s) 330 can enable the server 110 to become coupled to other systems, computer system, remote printers, and/or remote storage devices through intervening private or public networks. Modems, cable modems, transceivers, and Ethernet cards are examples of different types of network adapters 330 that can be used with the server 110.

As pictured in FIG. 3, the memory elements 310 can store the components of the server 110, for example an operating system 335, a web hosting server 340 and/or a text messaging server 345 and, optionally, a text message organizer 350. The text message organizer 350 can be implemented as a plug-in for the web hosting server 340 and/or a text messaging server 345, or can be a stand-alone application. Being implemented in the form of executable program code, these components of the server 110 can be executed by the server 110 and, as such, can be considered part of the server 110. Moreover, the operating system 335, web hosting server 340 and/or a text messaging server 345 and, optionally, text message organizer 350 are functional data structures that impart functionality when employed as part of the server 110. Further, the text messages processed by the operating system 335, web hosting server 340 and/or a text messaging server 345 and, optionally, text message organizer 350, including any parameters and/or attributes utilized to process text messages, are functional data structures that impart functionality when employed as part of server 110. Each text message, including any parameters and/or attributes utilized to process text messages, can be output to, and stored within, memory elements 310 and communicated to one or more of the client devices 120-124.

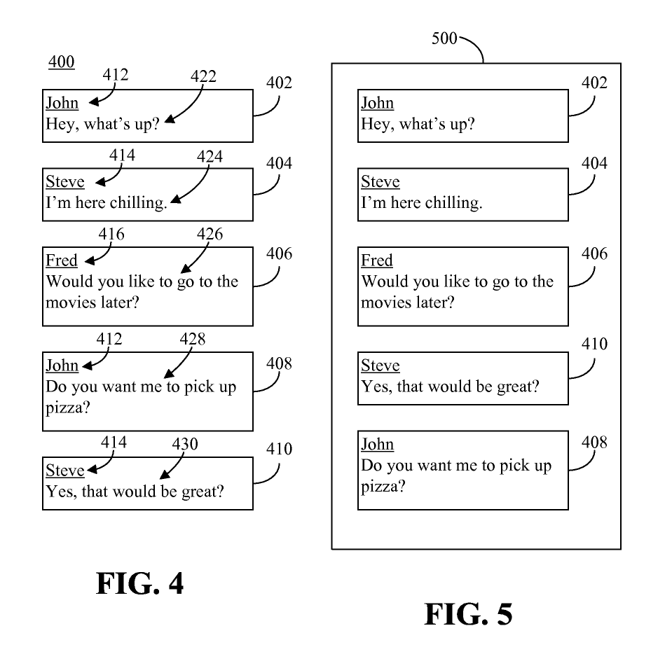

FIG. 4 is a diagram illustrating text messages exchanged among a plurality of users during a conversation 400. The conversation can include a plurality of text messages 402, 404, 406, 408, 410, each of which is generated by a user and communicated from the user's respective client device 120-124. In illustration, each text message 402-410 can be generated by a user using a respective text messaging client 260 or web browser 255, and communicated by the user's client device 120-124. Each text message 402-410 can indicate a user name 412, 414, 416 of a user who generated the text message 402-410, for example above the body 422, 424, 426, 428, 430 of the text message 402-410 or elsewhere in the text message 402-410.

In one arrangement, the text messages 402-410 can be received from the client devices 120-124 by the server(s) 110, processed by the server(s) 110, and routed to the other users' client devices 120-124 by the server(s) 110. The users can view the text messages 402-410 using their respective text messaging clients 260. In another arrangement, the text messages 402-410 can be received by the server(s) 110, processed by the server(s) 110, and posted in a chatroom or forum by the server(s) 110. The users can access the chatroom or forum to view the text messages 402-410 using the web browsers 255 of their respective client devices 120-124.

By way of example, the conversation 400 can begin with a user, John, sending a text message 402 asking a question, e.g., “Hey, what's up?” A user, Steve, can provide a text message 404 providing an answer to the question, e.g., “I'm here chilling.” Another user, Fred, can respond to the text message 402 with another text message 406 asking a question, e.g., “Would you like to go to the movies later?” The user John can provide another text message 408 asking another question, e.g., “Do you want me to pick up pizza?” The user Steve can provide a text message 410 providing an answer, e.g., “Yes, that would be great?” In this example, it is not clear whether the answer provided in the text message 410 provides pertains to the question provided in the text message 406 or the text message 408. The arrangements disclosed herein, however, provide a method of indicating to which text message 406, 408 the text message 410 pertains.

FIG. 5 is a diagram illustrating an example view 500, presented by respective user interfaces of the client device 120-124, via which the text messages 402-410 are presented on respective displays 230. In this example, the text messaging organizer 265 of each client device 120-124, or the text message organizer 350 of the server 110, can determine that the text message 410 contains an answer to the question asked in the text message 406 and, based on such determination, associate the text message 410 with the text message 406. For example, the text message 410 can be configured to be presented in the view 500 immediately below the text message 406, and above the text message 408. Thus, the text message 410 can be configured to be presented in a manner indicating that the answer contained in the text message 410 pertains to the question contained in the text message 406 and does not pertain to the question contained in the text message 408.

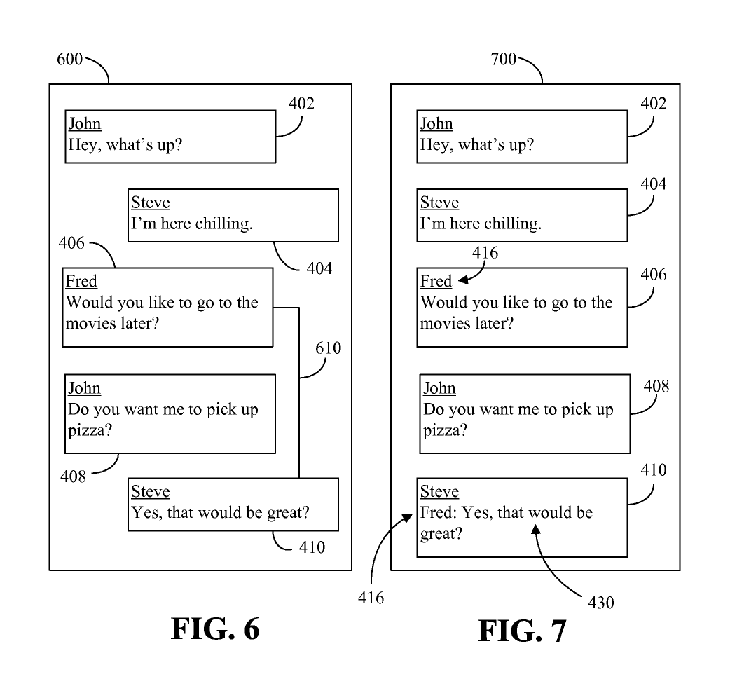

FIG. 6 is a diagram illustrating another example view 600, presented by respective user interfaces of the client device 120-124, via which the text messages 402-410 are presented on respective displays 230. In this example, the text messaging organizer 265 of each client device 120-124, or the text message organizer 350 of the server 110, can determine that the text message 410 contains an answer to the question asked in the text message 406 and, based on such determination, associate the text message 410 with the text message 406. For example, the text message 410 can be configured for presentation with a line connecting the text message 410 to the text message 406. Thus, the text message 410 can be configured to be presented in a manner indicating that the answer contained in the text message 410 pertains to the question contained in the text message 406 and does not pertain to the question contained in the text message 408.

FIG. 7 is a diagram illustrating another example view 700, presented by respective user interfaces of the client device 120-124, via which the text messages 402-410 are presented on respective displays 230. Again, the text messaging organizer 265 of each client device 120-124, or the text message organizer 350 of the server 110, can determine that the text message 410 contains an answer to the question asked in the text message 406 and, based on such determination, associate the text message 410 with the text message 406. In this example, the text messaging organizer 265 or the text message organizer 350 can identify a user name 416 of the user who generated the text message 406 (e.g., “Fred”). Further, text messaging organizer 265 or the text message organizer 350 can automatically insert that user name 416 into the text message 410. For example, the user name 416 can be inserted in the body 430 of the text message 410 before the text containing the answer, after the text containing the answer, or elsewhere in the text message 410. In one aspect, a symbol, such as a colon (:) or comma (,) can be automatically inserted after the user name 416 and before the text containing the answer. Thus, the text message 410 can be configured to be presented in a manner indicating that the answer contained in the text message 410 pertains to the question contained in the text message 406 and does not pertain to the question contained in the text message 408.

Still, the text message 410 can be presented in a manner indicating that the answer contained in the text message 410 pertains to the question contained in the text message 406, and does not pertain to the question contained in the text message 408, in any other suitable manner. Accordingly, the present arrangements are not limited in this regard.

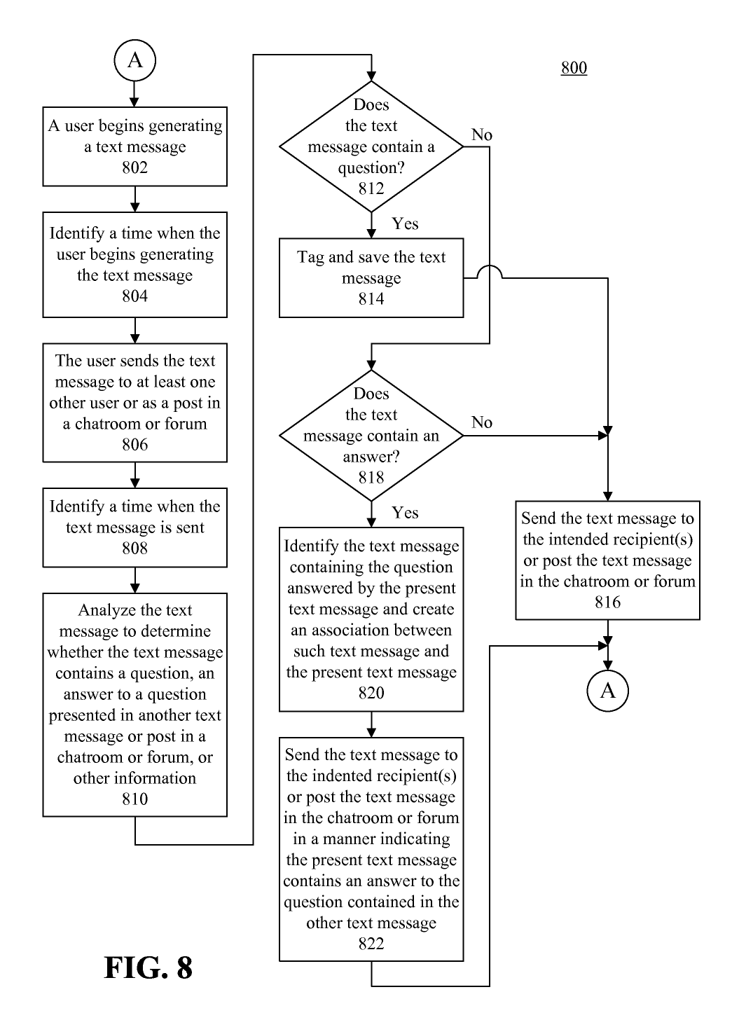

FIG. 8 is a flow chart illustrating an example of a method 800 of associating a text message containing an answer to a question with a text message containing the question. Referring to FIGS. 1-3 and 8, at step 802, a user of the client device 120 can begin generating a text message 140 using the client device 120. For example, the user can begin typing text into a text message input field presented by the text messaging client 260 or by the web browser 255 of the client device 120, begin speaking utterances detected by the client device 120 and converted into text using speech recognition, or enter text into the text message 140 in any other suitable manner.

At step 804, the text message organizer 265 (or the text messaging client 260) of the client device 120, or the text message organizer 350 of the server 110, can identify a time when the user begins generating the text message 140, even before the text message 140 is completed and sent. In an arrangement in which the text message organizer 265 identifies such time, for example, in an arrangement in which the user generates the text message 140 using the text messaging client 260, the text message organizer 265 can identify the time when the user begins generating the text message 140. The text message organizer 265 can generate data indicating such and add the data to the text message 140 as metadata or a time stamp. In an arrangement in which the user generates the text message 140 using a user interface presented on the client device 120 by the server 110, for example via the web browser 255 or another suitable application, the text message organizer 350 of the server 110 can identify the time when the user begins generating the text message 140.

At step 806, in one arrangement, the user can send the text message 140 to at least one other user, for example to the users of the client devices 122-124. The text message 140 can be routed through the server(s) 110 to the client devices 122-124, or presented by the server 110 to users of the client devices 122-124, for example via a web browser or other user interface. In another arrangement, the text message can be sent to the server 110 as post in a chatroom or forum. Users of the client devices 122-124 also can post text messages in the chatroom or forum.

At step 808, prior to text message being delivered to the client devices 122-124 or post in the chatroom or forum, the text message organizer 350 can determine a time when the text message 140 is sent by the client device 120. For example, the text message 140 can include a time stamp indicating when the text message 140 is sent. The text message organizer 350 also can determine when the user began generating the text message 140, for example based on the previously described metadata or time stamp added to the text message 140 indicating such, or based on time identified by the text message organizer 350.

At step 810, the text message organizer 350 can analyze the text message 140 and, optionally, other previously generated text messages in the conversation, to determine whether the text message 140 contains a question, an answer to a question presented in another text message or post in a chatroom or forum, or other information. To analyze the text message 140, the text message organizer 350 can perform natural language processing (NLP) and sematic analysis on words, phrases, sentences and/or paragraphs contained in the text message 140 and, optionally, other text messages previously generated in the conversation. NLP is a field of computer science, artificial intelligence and linguistics which implements computer processes to facilitate interactions between computer systems and human (natural) languages. NLP enables computers to derive computer-understandable meaning from natural language input. The International Organization for Standardization (ISO) publishes standards for NLP, one such standard being ISO/TC37/SC4. Semantic analysis is the implementation of computer processes to generate computer-understandable representations of natural language expressions. Semantic analysis can be used to construct meaning representations, semantic underspecification, anaphora resolution, presupposition projection and quantifier scope resolution, which are known in the art. Semantic analysis is frequently used with NLP to derive computer-understandable meaning from natural language input.

In addition to analyzing words, phrases and/or paragraphs contained in the text message 140 and, optionally, previous text messages, to determine whether the text message 140 contains a question, answer or other information, the NLP and/or semantic analysis can identify symbols contained in the text message 140. For example a question mark (?) contained in the text message 140 can be identified, which can indicate that the text message 140 contains a question. The NLP and/or semantic analysis also can identify other symbols contained in text message 140 to determine whether the text message 140 contains an answer to a question contained in a previous text message, and to which questions/text messages the answers are directed. In illustration, if a text message contains an ampersand (@) or hash (#) followed by a user name of a user (e.g., “@Fred” or “#Fred”), the NLP and/or semantic analysis can indicate that the text message contains an answer to an earlier text message generated by the identified user (e.g., Fred).

At decision box 812, the text message organizer 350 can, based on the analysis, determine whether the text message 140 contains a question. If so, at step 814 the text message organizer 350 can tag and save the text message 140. By tagging and saving the text message 140, the text message 140 will be available for further analysis when other text messages are received to determine whether any of those other text messages contain an answer to the question contained in the text message 140. In this regard, each text message in a conversation that contains a question can be added to a queue of such text messages maintained for that conversation. The text messages containing questions can be added to the queue in the order in which they are received. The queue can include a data repository in which the text messages are stored, at least temporarily, and a data structure (e.g., a data table) indicating each text message and the time each text message is received (e.g., time stamp). At step 816, the server can send the text message 140 to the intended recipient(s) or post the text message 140 in a chatroom or forum.

Referring again to decision box 812, if the text message 140 does not contain a question, at decision box 818 the text message organizer 350 can determine whether the text message 140 contains an answer. If the text message 140 does not contain an answer, the process can proceed to step 816, and the server 110 can send the text message 140 to the intended recipient(s) or post the text message 140 in a chatroom or forum.

Referring again to decision box 818, if the text message does contain an answer, at step 820 the text message organizer 350 can identify another text message containing the question answered by the text message 140. For example, the text message organizer 350 can access text messages contained in the previously described queue, and identify/select the other text message from the queue based on the NLP and/or semantic analysis performed on the text message 140 and text messages contained in the queue. For example, based on the NLP and/or semantic analysis, the text message organizer 350 can identify at least one text messages to which the answer contained in the text message 140 may pertain. In some cases, based only on NLP and/or semantic analysis, the NLP and/or semantic analysis, more than one text message contained in the queue may be identified.

Nonetheless, the text message organizer 350 also can determine when a user began generating the text message 140, based on the previously described data, to determine whether the text message 140 is a response to an earlier generated text message. For example, assume that a first text message is received at time t₀ presenting a first question and a second text message is received at time t₁ presenting a second question. Also assume that the text message 140 is identified by the text message organizer 350 as containing an answer to a question. Also assume that the text message 140 is received at time t₂, but the user began typing the text message 140 after time t₀ when the first text message is received, but before time t₁ when the second text message is received. In this case, since the user began typing the text message 140 after the first text message is received, but before the second text message is received, it can be determined that the answer does not pertain to the second text message, but instead may pertain to the first question contained in the first text message. NLP and/or semantic analysis performed on the first text message and the text message 140 can generate a level of confidence as to whether the text message 140 does indeed contain an answer to the first text message. If the level of confidence exceeds a threshold value, then the text message organizer 350 can determine that the text message 140 contains an answer to the question contained in the first text message.

In one non-limiting arrangement, the other text message to which the answer contained in the text message 140 pertains can be identified based on when the user began generating the text message 140, without performing NPL and/or semantic analysis. For example, if only one text message asking a question is contained in the queue when the user begins generating the text message 140, it may be clear that the answer contained in the text message 140 pertains to that question, and thus processing resources need not be dedicated to performing NPL and/or semantic analysis, thus improving system performance.

In addition, the text message organizer 350 can create an association between the text message 140 and the other text message containing the question answered by the text message 140. For example, the text message organizer 350 can add metadata to the text message 140 and/or the other text message indicating that the text message 140 contains an answer to the question asked in the other text message. In another example, the text message organizer 350 can create a record in a data structure (e.g., a data table or the like) indicating that the text message 140 contains an answer to the question asked in the other text message. Still, such association can be indicated in any other suitable manner and the present arrangements are not limited in this regard.

At step 822, the text message organizer 350 can send the text message 140 to the indented recipient(s) or post the text message in the chatroom or forum in a manner indicating the text message 140 contains an answer to the question contained in the other text message. For example, in the case that the text message 140 is sent from the client device 120 to one or more other recipients, in one arrangement the text message organizer 350 can add to the text message 140 metadata indicating the relationship between the text message 140 and the other text message. The text messaging clients 260 and/or text message organizers 265 of the client devices 122-124 can process the metadata to present the text message 140 on respective displays 230 in a manner that associates the text message 140 with the other text message, for example as described for FIGS. 5-6 with respect to the text messages 410 and 406. In another arrangement, the text message organizer 350 can add to the text message 140 the user name of the user who sent the other text message containing the question answered by the text message 140, for example as described with regard to FIG. 7. The text messaging clients 260 can present on respective displays 230 the text message 140 with the user name. Further, the server 110 can send the text message 140, with the metadata or the user name, back to the client device 120, and the client device can replace the originally generated text message with the one including the metadata or the user name and arrange the text message 140 and the other text message, for example as described for FIGS. 5-7.

The process can return to step 802 and be implemented for other text messages generated during the conversation.

At this point it should be noted that in other arrangements various steps described in the method 800 of FIG. 8 can be performed by the client devices 120-124 in lieu of the server 110. For example, rather than the text message 140 being sent at step 806, at step 806 the user can initiate sending of the text message 140, but the client device 120 can refrain from sending the text message 140 until step 816. In this regard, the text message organizer 265 of the client device 120 can perform the processes described at steps 804, 808, 810, 814, and 820 and decision boxes 812 and 818. Further, the text messaging client 260 can perform the processes described at steps 816 and 822. Thus, although the text message 140 may be routed through the server 110 when sent from the client device 120 to the client devices 122-124 at step 816, the method 800 can be performed without requiring the text message organizer 350 being present on the server 110. Accordingly, certain arrangements can be implemented using a text message organizer 265 plugin or application installed on the client devices 120-124.

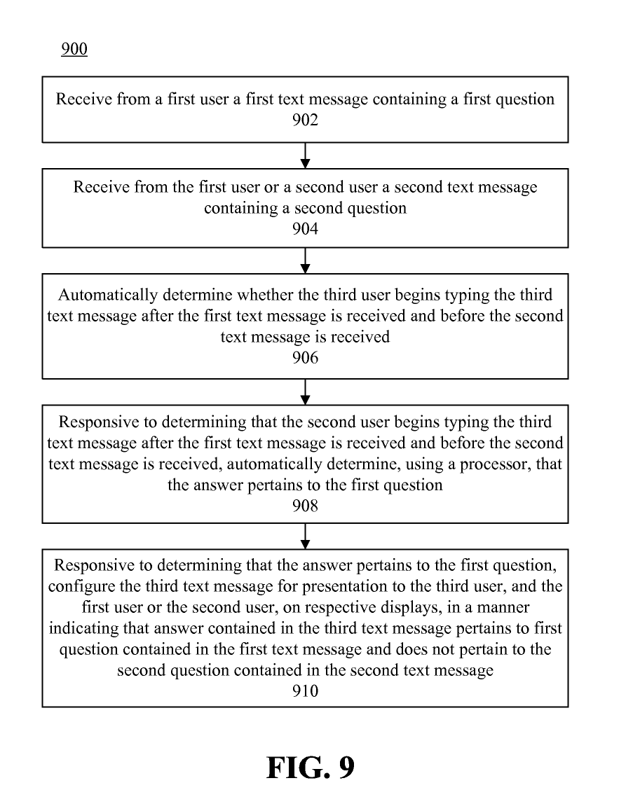

FIG. 9 is a flow chart illustrating another example of a method 900 of associating a text message containing an answer to a question with a text message containing the question. The method 900 presents a process that may be implemented by the text message organizer 265 of the client devices 120 or the text message organizer 350 of the server 110.

At step 902, a first text message containing a first question can be received from a first user. At step 904, a second text message containing a second question can be received from the first user or a second user. At step 906, whether the third user begins typing the third text message after the first text message is received and before the second text message is received can be automatically determined. At step 908, responsive to determining that the second user begins typing the third text message after the first text message is received and before the second text message is received, an automatic determination can be made, using a processor, that the answer pertains to the first question. At step 910, responsive to determining that the answer pertains to the first question, the third text message can be configured for presentation to the third user, and the first user or the second user, on respective displays, in a manner indicating that answer contained in the third text message pertains to first question contained in the first text message and does not pertain to the second question contained in the second text message.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” or similar language means that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving from a first user a first text message containing a first question;
receiving from the first user or a second user a second text message containing a second question;
receiving from a third user a third text message containing an answer;
automatically determining whether the third user begins typing the third text message after the first text message is received and before the second text message is received;
responsive to determining that the second user begins typing the third text message after the first text message is received and before the second text message is received, automatically determining, using a processor, that the answer pertains to the first question; and
responsive to determining that the answer pertains to the first question, configuring the third text message for presentation to the third user, and the first user or the second user, on respective displays in a manner indicating that answer contained in the third text message pertains to first question contained in the first text message and does not pertain to the second question contained in the second text message.

2. The method of claim 1, wherein configuring the third text message for presentation to the third user, and the first user or the second user, on respective displays, in a manner indicating that answer contained in the third text message pertains to first question contained in the first text message and does not pertain to the second question contained in the second text message comprises:
configuring the third text message for presentation immediately below the first text message and above the second text message.

3. The method of claim 1, wherein configuring the third text message for presentation to the third user, and the first user or the second user, on respective displays, in a manner indicating that answer contained in the third text message pertains to first question contained in the first text message and does not pertain to the second question contained in the second text message comprises:
configuring the third text message for presentation with a line connecting the third text message to the first text message.

4. The method of claim 1, wherein configuring the third text message for presentation to the third user, and the first user or the second user, on respective displays, in a manner indicating that answer contained in the third text message pertains to first question contained in the first text message and does not pertain to the second question contained in the second text message comprises:
inserting into the third text message a user name of a user who generated the first text message.

5. The method of claim 1, wherein automatically determining, using a processor, that the answer pertains to the first question further comprises:
identifying in the third text message a symbol and a user name of a user who generated the first text message.

6. The method of claim 1, wherein automatically determining, using a processor, that the answer pertains to the first question further comprises:
determining, using natural language processing, that the third text message contains the answer to the first question contained in the first text message.

7. The method of claim 1, further comprising:
identifying that the first text message asks the first question by identifying a question mark in the first text message.

8. A system, comprising:
a processor programmed to initiate executable operations comprising:
receiving from a first user a first text message containing a first question;
receiving from the first user or a second user a second text message containing a second question;
receiving from a third user a third text message containing an answer;
automatically determining whether the third user begins typing the third text message after the first text message is received and before the second text message is received;
responsive to determining that the second user begins typing the third text message after the first text message is received and before the second text message is received, automatically determining that the answer pertains to the first question; and
responsive to determining that the answer pertains to the first question, configuring the third text message for presentation to the third user, and the first user or the second user, on respective displays in a manner indicating that answer contained in the third text message pertains to first question contained in the first text message and does not pertain to the second question contained in the second text message.

9. The system of claim 8, wherein configuring the third text message for presentation to the third user, and the first user or the second user, on respective displays, in a manner indicating that answer contained in the third text message pertains to first question contained in the first text message and does not pertain to the second question contained in the second text message comprises:
configuring the third text message for presentation immediately below the first text message and above the second text message.

10. The system of claim 8, wherein configuring the third text message for presentation to the third user, and the first user or the second user, on respective displays, in a manner indicating that answer contained in the third text message pertains to first question contained in the first text message and does not pertain to the second question contained in the second text message comprises:
configuring the third text message for presentation with a line connecting the third text message to the first text message.

11. The system of claim 8, wherein configuring the third text message for presentation to the third user, and the first user or the second user, on respective displays, in a manner indicating that answer contained in the third text message pertains to first question contained in the first text message and does not pertain to the second question contained in the second text message comprises:
inserting into the third text message a user name of a user who generated the first text message.

12. The system of claim 8, wherein automatically determining, using a processor, that the answer pertains to the first question further comprises:
identifying in the third text message a symbol and a user name of a user who generated the first text message.

13. The system of claim 8, wherein automatically determining, using a processor, that the answer pertains to the first question further comprises:
determining, using natural language processing, that the third text message contains the answer to the first question contained in the first text message.

14. The system of claim 8, the executable operations further comprising:
identifying that the first text message asks the first question by identifying a question mark in the first text message.

15. A computer program product comprising a computer readable storage medium having program code stored thereon, the program code executable by a processor to perform a method comprising:
receiving, by the processor, from a first user a first text message containing a first question;
receiving, by the processor, from the first user or a second user a second text message containing a second question;
receiving, by the processor, from a third user a third text message containing an answer;
automatically determining, by the processor, whether the third user begins typing the third text message after the first text message is received and before the second text message is received;
responsive to determining that the second user begins typing the third text message after the first text message is received and before the second text message is received, automatically determining, by the processor, that the answer pertains to the first question; and
responsive to determining that the answer pertains to the first question, configuring, by the processor, the third text message for presentation to the third user, and the first user or the second user, on respective displays in a manner indicating that answer contained in the third text message pertains to first question contained in the first text message and does not pertain to the second question contained in the second text message.

16. The computer program product of claim 15, wherein configuring the third text message for presentation to the third user, and the first user or the second user, on respective displays, in a manner indicating that answer contained in the third text message pertains to first question contained in the first text message and does not pertain to the second question contained in the second text message comprises:
configuring the third text message for presentation immediately below the first text message and above the second text message.

17. The computer program product of claim 15, wherein configuring the third text message for presentation to the third user, and the first user or the second user, on respective displays, in a manner indicating that answer contained in the third text message pertains to first question contained in the first text message and does not pertain to the second question contained in the second text message comprises:
configuring the third text message for presentation with a line connecting the third text message to the first text message.

18. The computer program product of claim 15, wherein configuring the third text message for presentation to the third user, and the first user or the second user, on respective displays, in a manner indicating that answer contained in the third text message pertains to first question contained in the first text message and does not pertain to the second question contained in the second text message comprises:
inserting into the third text message a user name of a user who generated the first text message.

19. The computer program product of claim 15, wherein automatically determining, using a processor, that the answer pertains to the first question further comprises:
identifying in the third text message a symbol and a user name of a user who generated the first text message.

20. The computer program product of claim 15, wherein automatically determining, using a processor, that the answer pertains to the first question further comprises:
determining, using natural language processing, that the third text message contains the answer to the first question contained in the first text message.
